(19) United States
(12) Patent Application Publication
(10) Pub. No.: US 2006/0181334 A1
(43) Pub. Date: Aug. 17, 2006

(54) High voltage generator for use in semiconductor memory device

(75) Inventor: Chang-Ho Do, Kyoungki-do (KR)

Correspondence Address: MAYER, BROWN, ROWE & MAW LLP, 1909 K STREET, N.W., WASHINGTON, DC, 20006, US

(73) Assignee: Hynix Semiconductor Inc.

(21) Appl. No.: 11/320,853

(22) Filed: Dec. 30, 2005

(30) Foreign Application Priority Data
Jan. 31, 2005 (KR) 10-2005-0008708

(51) Int. Cl. G05F 1/10

(52) U.S. Cl. 327/538

(57) ABSTRACT

The present invention generates a boosted voltage by preventing a latch-up phenomenon during an initial operating time, i.e., when a power voltage is initially inputted. The present invention includes a level-detecting block for comparing an high voltage with a high reference voltage and for generating a level detect signal; an oscillating block that is enabled to generate a periodic pump signal based on the level detect signal; a charge-pumping block for performing a pumping operation to generate the high voltage in response to the periodic pump signal; and an initial block for preventing a latch-up phenomenon by minimizing level differences between a power voltage and the high voltage before the power voltage reaches to a predetermined level where the pumping operation is guaranteed.

### FIELD OF INVENTION

The present invention relates to an internal function block for use in a semiconductor memory device; and, more particularly, to a high voltage generator for stably generating a high voltage boosted from an inputted power voltage.

### DESCRIPTION OF RELATED ARTS

Generally, a semiconductor memory device includes an internal voltage generator for generating an internal voltage based on a power voltage inputted from an exterior of the semiconductor memory device in order to supply the internal voltage to other functional blocks in the semiconductor memory device. Thus, it is very important that the internal voltage is stably generated and supplied by the internal voltage generator.

Recently, as wire width in the semiconductor memory device becomes narrower in order to increase integration of the semiconductor memory device, and as economy of power in the semiconductor memory device is requested, the level of the power voltage that is required becomes lower. That is, the semiconductor memory device can be stably operated under a low power condition.

In the low power condition, in order to compensate for a voltage loss generated due to a threshold voltage of transistor and maintaining an appropriate level of data, the semiconductor memory device must have a high voltage VPP that has a higher predetermined voltage level than an inputted power voltage VDD.

Particularly, in a dynamic random access memory DRAM, a word-line driver, a bit-line connector, a data output buffer and other functional blocks are widely used for compensating the voltage loss due to the threshold voltage of a transistor.

Meanwhile, if the power voltage VDD is inputted from the exterior of the semiconductor memory device, then the internal voltage generator can generate plural internal voltages, wherein each has a different level. However, during the period between the initial (or power-up) operation and the point where power voltage VDD is stably supplied with a predetermined level after the power voltage VDD is initially inputted, a level of the power voltage VDD is unstable; and, as a result, an error such as a latch-up phenomenon generated due to a parasitic capacitor at a junction between a transistor and a well region included in the semiconductor memory device can occur.

FIG. 1 is a cross-sectional view which describes a CMOS inverter embodied in a semiconductor wafer. Also, FIG. 2 is a schematic circuit diagram modeling a latch-up phenomenon due to a parasitic capacitor between a transistor and a well region shown in FIG. 1. Hereinafter, referring to FIGS. 1 and 2, the latch-up phenomenon will be described in detail.

Typically, referring to FIG. 1, a voltage supplied at a source of a MOS transistor is different from that at a body of the MOS transistor in a semiconductor device. For example, in a case of NMOS transistor, a power ground VSS is supplied at a source and a back bias voltage VBB having a lower level than the power ground VSS is supplied at a body. Also, in a case of PMOS transistor, a power voltage (or a power core VDD or VCORE) is supplied at a source and a high voltage VPP having a higher level than the power voltage or the power core VDD or VCORE is supplied at a body.

In these cases, when a level of the power voltage VDD inputted from the exterior of the semiconductor memory device is rapidly increased, the high voltage VPP cannot be kept up with an increasing speed of the power voltage VDD. Due to a voltage difference between the rapidly increased power voltage VDD and the more slowly-boosted high voltage VPP, a parasitic bipolar transistor (as shown in FIG. 2) is turned on and, as a result, an excess amount of current is flowed both through paths between the high voltage VPP and the power ground VSS and between the power voltage VDD and the power ground VSS. This is called a latch-up phenomenon.

In order to prevent the latch-up phenomenon, an internal voltage generator should be included as an initial control block for boosting a level of the high voltage VPP during the initial operation when a pumping operation of the internal voltage generator is not guaranteed because of unstable power voltage.

FIG. 3 is a block diagram showing a conventional high voltage generator for generating a high voltage VPP.

As shown, the conventional high voltage generator includes a level detector 10, an oscillator 20, a charge pump 30 and an initial block 40.

The level detector 10 compares the high voltage VPP with a high reference voltage VREF_PP to generate a level detect signal PPE having a logic high level when a level of the high voltage VPP is lower than that of the high reference voltage VREF_PP. In response to the level detect signal PPE having the logic high level, the oscillator 20 is enabled to output a periodic pump signal tOSC to the charge pump 30. The charge pump 30, in response to a toggling of the periodic pump signal tOSC, then performs a pumping operation by using a power voltage VDD to generate the high voltage VPP. Lastly, the initial block 40 functions to lead a level of the high voltage VPP during the initial operation period when the pumping operation of the charge pump 30 is not guaranteed because of unstable initial power voltage VDD.

Herein, the initial block 40 includes a NMOS transistor M1 which is coupled between the power voltage VDD and an output node of the charge pump 30.

FIG. 4 is a timing diagram describing an operation of the conventional high voltage generator shown in FIG. 3. Hereinafter, referring to FIGS. 3 and 4, the operation of the conventional high voltage generator will be described in detail.

When the high voltage VPP is lower than the high reference voltage VREF_PP, the level detector 10 activates a level detect signal PPE. The activated level detect signal PPE enables the oscillator 20, which then generates a periodic pump signal tOSC. In response to the periodic pump signal tOSC, the charge pump 30 performs a pumping operation based on the power voltage VDD.

Meanwhile, since the charge pump 30 cannot be operated stably before the power voltage VDD is stably supplied with a predetermined level after initial input of the power voltage VDD, the high voltage VPP that is generated from the charge pump 30 is unstable because the pumping operation of the charge pump 30 cannot be guaranteed. Thus, the initial block 40 generates a high voltage VPP which has a level in proportion with a level of the power voltage VDD.

Herein, an NMOS transistor M1 which is included in the initial block 40 is turned on to thereby increase the level of the high voltage VPP when inputted power voltage VDD is larger than a threshold voltage Vt of the NMOS transistor M1.

However, as above described, though the initial block 40 increases the level of the high voltage VPP, it only does so up to a maximum high voltage VPP level of VDD−Vt (i.e., a level attained by subtracting the threshold voltage Vt of the NMOS transistor M1 from the high voltage VPP) during an initial operation of the high voltage generator. Further, the maximum high voltage VPP level can be decreased due to a resistance of wires and loads. Therefore, if a level difference between the power voltage VDD and the high voltage VPP is over a built-in potential of dopant diffusion region in a semiconductor device, wherein the built-in potential is generally about 0.7V, a parasitic PN junction is turned on in a forward direction; and, as a result, the latch-up phenomenon occurs.

### SUMMARY OF THE INVENTION

It is, therefore, an object of the present invention to provide an apparatus for generating a boosted voltage by preventing a latch-up phenomenon during an initial operating time, i.e., when a power voltage is initially inputted.

In accordance with an aspect of the present invention, an apparatus is provided for generating an internal high voltage, including a level-detecting block for comparing a high voltage with a high reference voltage and generating a level detect signal based on the comparison; an oscillating block that is enabled to generate a periodic pump signal based on the level detect signal; a charge-pumping block for performing a pumping operation to generate the high voltage in response to the periodic pump signal; and an initial block for preventing a latch-up phenomenon by minimizing level differences between a power voltage and the high voltage before the power voltage reaches a predetermined level where the pumping operation is guaranteed.

In accordance with another aspect of the present invention, there is a semiconductor memory device for generating an internal high voltage, including a level-detecting block for comparing an high voltage with a high reference voltage and for generating a level detect signal based on the comparison; an oscillating block that is enabled to generate a periodic pump signal based on the level detect signal; a charge-pumping block for performing a pumping operation to generate the high voltage in response to the periodic pump signal; and an initial block for preventing a latch-up phenomenon by minimizing level differences between a power voltage and the high voltage during an initial operation.

### BRIEF DESCRIPTION OF THE DRAWINGS

The above and other objects and features of the present invention will become better understood with respect to the following description of the specific embodiments given in conjunction with the accompanying drawings, in which:

FIG. 1 is a cross sectional view describing a CMOS inverter embodied in a conventional semiconductor wafer;

FIG. 2 is a schematic circuit diagram modeling a latch-up phenomenon due to a parasitic capacitor between a transistor and a well region shown in FIG. 1;

FIG. 3 is a block diagram showing a conventional internal voltage generator for generating a high voltage VPP;

FIG. 4 is a timing diagram describing an operation of the conventional high voltage generator shown in FIG. 3;

FIG. 5 is a block diagram showing an internal high voltage generating block in accordance with an embodiment of the present invention;

FIG. 6A is a schematic circuit diagram depicting an initial level detector in accordance with an embodiment of the present invention;

FIG. 6B is a schematic circuit diagram depicting an initial level detector in accordance with another embodiment of the present invention; and

FIG. 7 is a timing diagram describing an operation of the internal high voltage generator shown in FIG. 5.

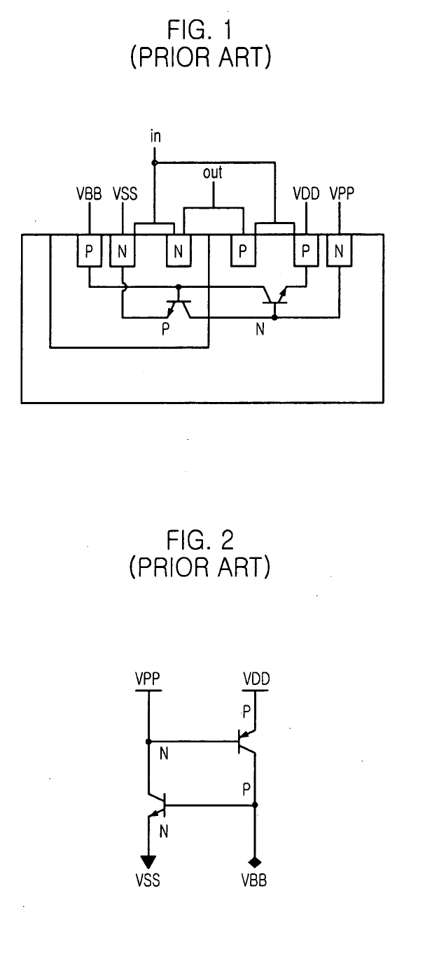

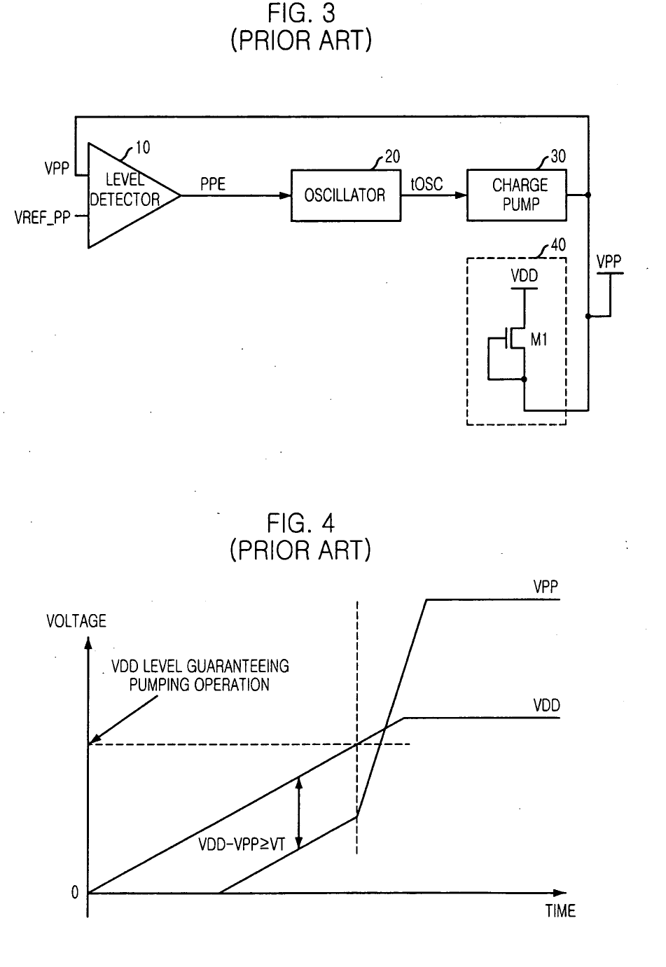

### DETAILED DESCRIPTION OF THE INVENTION

Hereinafter, a semiconductor device in accordance with an embodiment of the present invention will be described in detail with reference to the accompanying drawings.

An apparatus for generating an internal high voltage-generating block according to the present invention can be applied to a semiconductor memory device or other controllers using plural internal high voltage, each having different level.

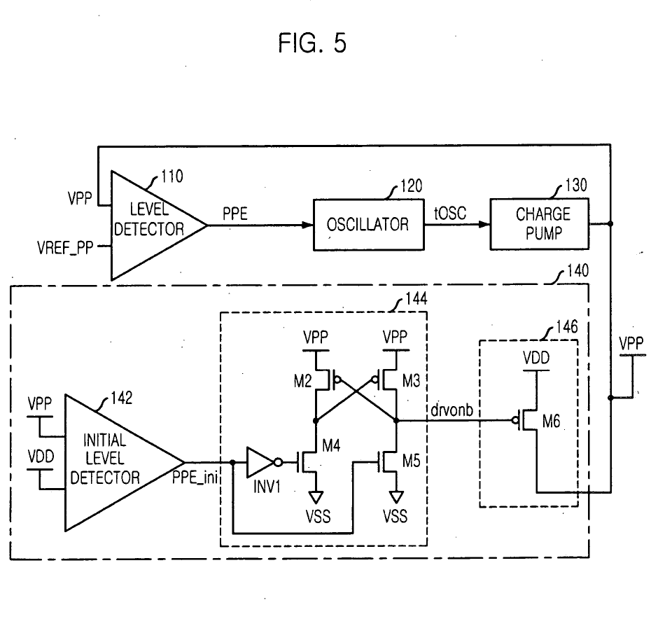

FIG. 5 is a block diagram showing an internal high voltage-generating block in accordance with an embodiment of the present invention.

As shown, the internal high voltage-generating block includes a level detector 110, an oscillator 120, a charge pump 130 and an initial block 140.

The level detector 110 compares the high voltage VPP with a high reference voltage VREF_PP and generates a level detect signal PPE having a logic high level when the level of the high voltage VPP is lower than that of the high reference voltage VREF_PP. In response to the level detect signal PPE having the logic high level, the oscillator 120 is enabled to output a periodic pump signal tOSC to the charge pump 130. The charge pump 130 performs a pumping operation to generate the high voltage VPP by using a power voltage VDD in response to a toggling of the periodic pump signal tOSC. Lastly, the initial block 140 functions to lead a level of the high voltage VPP during initial operation when the pumping operation of the charge pump 130 is not guaranteed, because of unstable initial power voltage VDD.

Herein, the initial block 140 prevents a latch-up phenomenon by minimizing a level difference between the power voltage VDD and the high voltage VPP, before the power voltage VDD reaches a predetermined level where the pumping operation of the charge pump block 130 is guaranteed.

Further, the initial block 140 includes an initial level detector 142, a signal converter 144 and a pull-up driver 146. The initial level detector 142 compares the high voltage VPP with the power voltage VDD and, based on the comparison result, generates an initial level detect signal PPE_ini. The initial level detect signal PPE_ini is received by the signal converter 144, which then converts the initial level detect signal PPE_ini into a pull-up control signal drvonb. The pull-up driver 146 increases a level of the high voltage VPP in response to the pull-up control signal drvonb by using the power voltage VDD.

In detail, referring to FIG. 5, the signal converter 144 comprises a level shifter for converting an initial level detect signal PPE-ini into a pull-up control signal drvonb, based on the high voltage VPP. The level shifter includes first and second PMOS transistors M2 and M3, first and second NMOS transistors M4 and M5 and an first inverter INV1.

The first and second PMOS transistors M2 and M3 are respectively coupled to the high voltage VPP. Herein, a gate of the first PMOS transistor M2 is coupled to a drain of the second PMOS transistor M3; and a gate of the second PMOS transistor M3 is coupled to a drain of the second PMOS transistor M2. The first NMOS transistor M4 is coupled between the power ground VSS and the drain of the first PMOS transistor M2, and has a gate for receiving an inverted initial level detect signal outputted from a first inverter INV1. The second NMOS transistor M5 is coupled between the power ground VSS and the drain of the second PMOS transistor M3, and has a gate for receiving the initial level detect signal PPE_ini.

In addition, the pull-up control signal drvonb is outputted from an output node between the second PMOS transistor M3 and the second NMOS transistor M5.

Moreover, the pull-up driver 146 includes a third PMOS transistor M6 having a gate for receiving the pull-up control signal drvonb. The PMOS transistor M6 is coupled between the power voltage VDD and an output node of the charge pumping block 130.

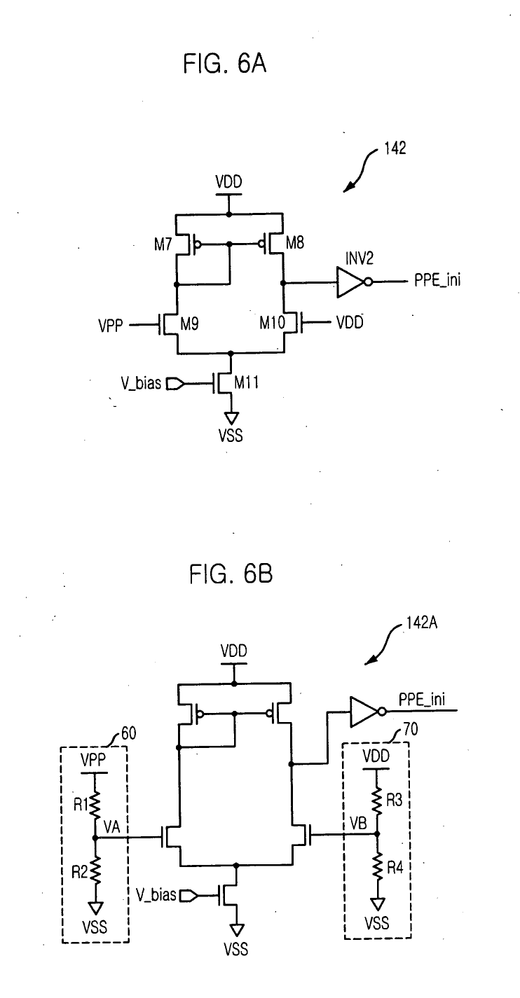

FIG. 6A is a schematic circuit diagram depicting an initial level detector 142 in accordance with an embodiment of the present invention.

As shown, the initial level detector 142 constitutes a differential amplifier having a current mirror circuit.

In detail, the initial level detector 142 includes a third NMOS transistor M11 coupled to the power ground VSS for flowing a current in response to a bias voltage V_bias inputted at a gate; a fourth NMOS transistor M9 is coupled to the third NMOS transistor M11 for receiving the high voltage VPP inputted at a gate; a fifth NMOS transistor M10 is coupled to the third NMOS transistor M11 for receiving the power voltage VDD inputted at a gate; a diode-connected PMOS transistor M7 is coupled between the power voltage VDD and the fourth NMOS transistor M9; and a fourth PMOS transistor M8 is coupled between the power voltage VDD and the fifth NMOS transistor M10, wherein a gate of the fourth PMOS transistor M8 is coupled to a gate of the diode-connected PMOS transistor M7. Herein, the diode-connected PMOS transistor M7 and the fourth PMOS transistor M8 are served as a current mirror circuit.

The initial level detector 142 also includes a second inverter INV2 fork inverting a voltage loaded on a node between the fourth PMOS transistor M8 and the fifth NMOS transistor 10 and outputting the inverted voltage as an initial level detect signal PPE_ini.

In particular, the initial level detector 142 generates an initial level detect signal PPE_ini having a logic low level if the high voltage VPP is higher than the power voltage VDD. However, if the high voltage VPP is lower than the power voltage VDD, then the initial level detector 142 generates an initial level detect signal PPE_ini having a logic high level.

FIG. 6B is a schematic circuit diagram depicting an initial level detector 142A in accordance with another embodiment of the present invention.

As shown, the initial level detector 142A compares outputs of first and second voltage dividers 60 and 70, unlike the initial level detector, shown in FIG. 6A, which compares the high voltage VPP with the power voltage VDD directly.

The initial level detector 142A includes a first voltage divider 60 for dividing a level of the high voltage by using first and second resistors, the second voltage divider 70 for dividing a level of the power voltage by using third and fourth resistors and a differential amplifier for comparing outputs of the first and second voltage dividers 60 and 70 to generate an initial level detect signal PPE_ini. Herein, the differential amplifier is the same as the initial level detector shown in FIG. 6A in a view of structure.

The first voltage divider 60 includes a first resistor R1 and a second resistor R2. The second voltage divider 70 includes a third resistor R3 and a fourth resistor R4.

Referring to FIG. 6B, if a first resistance ratio between the first and second resistors R1 and R2 is the same as a second resistance ratio between the third and fourth resistors R3 and R4, then the initial level detect signal PPE_ini outputted from the initial level detector 142A (shown in FIG. 6B) is the same as that shown in FIG. 6A. However, as the first and the second resistances are adjusted, operation of the charge pump block 130 and initial operation of the internal high voltage-generating block according to a difference between the high voltage VPP and the power voltage VDD can be controlled.

In addition, as would be known by those skilled in the art, resistors R1 to R4 can be embodied by active resistors such as MOS transistors.

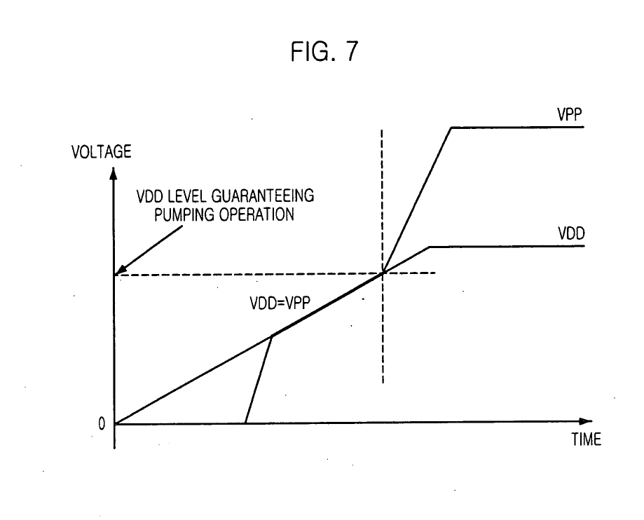

FIG. 7 is a timing diagram describing an operation of the internal high voltage generator shown in FIG. 5.

In particular, the level detector 110 activates a level detect signal PPE when the high voltage VPP is lower than a high reference voltage VREF_PP. The activated level detect signal PPE enables an oscillator 120, which then generates a periodic pump signal tOSC. In response to the periodic pump signal tOSC, a charge pump 130 performs a pumping operation.

The pumping operation of the charge pump 130, however, is not guaranteed at an initial operating time, i.e., while the high voltage VPP is lower than the power voltage VDD. At this time, the initial level detect signal PPE_ini that is outputted from the initial level detector 142 is activated as a logic high level. Thus, the pull-up control signal drvonb becomes a level of the power ground VSS; and, the first PMOS transistor M6 is enabled so that the power voltage VDD is outputted as the high voltage VPP. Herein, no voltage drop occurs at the first PMOS transistor M6 and the level of high voltage VPP is substantially the same as that of the power voltage VDD.

Then, if the power voltage VDD inputted from an external source reaches a predetermined level at which the pumping operation is guaranteed, then the charge pumping block 130 is operated normally to thereby rapidly increase a level of the high voltage VPP.

Meanwhile, as above described, if the high voltage VPP is higher than the power voltage VDD, an initial level detect signal PPE_ini is inactivated as a logic low level. Thus, the pull-up control signal drvonb becomes a level of the high voltage VPP so that the first PMOS transistor M6 is turned off.

Finally, after the pull-up driver 146 is disabled, the power voltage VDD is continuously increased to a desired level and the high voltage VPP is increased to a target level, i.e., a level of the high reference voltage VREF_PP.

In an embodiment of the present invention, as described above, the high voltage VPP has the same level as the power voltage VDD before the power voltage VDD reaches a predetermined level at which a pumping operation is guaranteed. As a result, any difference between the high voltage VPP and the power voltage VDD is removed. Therefore, suppression of any parasitic PN junction in an internal of the semiconductor device and of a latch-up phenomenon is ensured.

The present invention can prevent the occurrence of a latch-up phenomenon during an initial operating time when a power voltage is initially inputted due to a difference between the high voltage and the power voltage. As a result, operational reliability of the semiconductor memory device is improved.

The present application contains subject matter related to the Korean patent application No. KR 2005-008708, filed in the Korean Patent Office on Jan. 31, 2005, the entire contents of which being incorporated herein by reference.

While the present invention has been described with respect to certain specific embodiments, it will be apparent to those skilled in the art that various changes and modifications may be made without departing from the spirit and scope of the invention as defined in the following claims.

What is claimed is:

1. An apparatus for generating an internal high voltage, comprising:
a level-detecting block for comparing a high voltage with a high reference voltage and generating a level detect signal based on the comparison;
an oscillating block that is enabled to generate a periodic pump signal based on the level detect signal;
a charge-pumping block for performing a pumping operation to generate a high voltage in response to the periodic pump signal; and
an initial block for preventing a latch-up phenomenon by minimizing level differences between a power voltage and the high voltage before the power voltage reaches a predetermined level where the pumping operation is guaranteed.

2. The apparatus as recited in claim 1, wherein the initial block includes:
an initial level detector for comparing the high voltage with the power voltage in order to generate an initial level detect signal;
a signal converter for converting the initial level detect signal into a pull-up control signal; and
a pull-up driver for pulling up a level of the high voltage in response to the pull-up control signal.

3. The apparatus as recited in claim 2, wherein the pull-up driver includes a PMOS transistor having a gate for receiving the pull-up control signal, and wherein the PMOS transistor is coupled between the power voltage and an output node of the charge pumping block.

4. The apparatus as recited in claim 2, wherein the signal converter includes a level shifter for converting the initial level detect signal into a pull-up control signal based on the high voltage.

5. The apparatus as recited in claim 4, wherein the level shifter includes:
first and second PMOS transistors, each having a source coupled to the high voltage, wherein a gate of the first PMOS transistor is coupled to a drain of the second PMOS transistor, and wherein a gate of the second PMOS transistor is coupled to a drain of the second PMOS transistor;
a first NMOS transistor, coupled between a power ground and the drain of the first PMOS transistor, having a gate for receiving an inverted initial level detect signal; and
a second NMOS transistor, coupled between the power ground and the drain of the second PMOS transistor, having a gate for receiving the initial level detect signal, wherein the pull-up control signal is outputted from an output node that is coupled between the second PMOS transistor and the second NMOS transistor.

6. The apparatus as recited in claim 2, wherein the initial level detector includes a differential amplifier for comparing the high voltage with the power voltage to generate the initial level detect signal, wherein the differential amplifier comprises an NMOS bias transistor.

7. The apparatus as recited in claim 2, wherein the initial level detector includes:
a first voltage divider for dividing a level of the high voltage by using first and second resistors;
a second voltage divider for dividing a level of the power voltage by using third and fourth resistors; and
a differential amplifier for comparing outputs of the first and second voltage dividers, and for generating the initial level detect signal based on the comparison.

8. The apparatus as recited in claim 7, wherein a first resistance ratio between the first and second resistors is different from a second resistance ratio between the third and fourth resistors.

9. The apparatus as recited in claim 8, wherein the first, second, third and fourth resistors are active resistors.

10. The apparatus as recited in claim 1, wherein the level detect signal is generated as a logic high level when the high voltage is lower than the high reference voltage.

11. A semiconductor memory device for generating an internal high voltage, comprising:
a level-detecting block for comparing a high voltage with a high reference voltage and generating a level detect signal based on the comparison;
an oscillating block that is enabled to generate a periodic pump signal based on the level detect signal;
a charge-pumping block for performing a pumping operation to generate a high voltage in response to the periodic pump signal; and
an initial block for preventing a latch-up phenomenon by minimizing level differences between a power voltage and the high voltage during an initial operation.

12. The semiconductor memory device as recited in claim 11, wherein the initial block includes:
an initial level detector for comparing the high voltage with the power voltage in order to generate an initial level detect signal;
a signal converter for converting the initial level detect signal into a pull-up control signal; and
a pull-up driver for pulling up a level of the high voltage in response to the pull-up control signal.

13. The semiconductor memory device as recited in claim 12, wherein the pull-up driver includes a PMOS transistor having a gate for receiving the pull-up control signal, and wherein the PMOS transistor is coupled between the power voltage and an output node of the charge pumping block.

14. The semiconductor memory device as recited in claim 12, wherein the signal converter includes a level shifter for converting the initial level detect signal into a pull-up control signal based on the high voltage.

15. The semiconductor memory device as recited in claim 14, wherein the level shifter includes:
first and second PMOS transistors, each having a source coupled to the high voltage, wherein a gate of the first PMOS transistor is coupled to a drain of the second PMOS transistor, and wherein a gate of the second PMOS transistor is coupled to a drain of the second PMOS transistor;
a first NMOS transistor, coupled between a power ground and the drain of the first PMOS transistor, having a gate for receiving an inverted initial level detect signal; and
a second NMOS transistor, coupled between the power ground and the drain of the second PMOS transistor, having a gate for receiving the initial level detect signal,
wherein the pull-up control signal is outputted from an output node that is coupled between the second PMOS transistor and the second NMOS transistor.

16. The semiconductor memory device as recited in claim 12, wherein the initial level detector includes a differential amplifier for comparing the high voltage with the power voltage to generate the initial level detect signal, wherein the differential amplifier comprises a NMOS bias transistor.

17. The semiconductor memory device as recited in claim 12, wherein the initial level detector includes:
a first voltage divider for dividing a level of the high voltage by using first and second resistors;
a second voltage divider for dividing a level of the power voltage by using third and fourth resistors; and
a differential amplifier for comparing outputs of the first and second voltage dividers, and for generating the initial level detect signal based on the comparison.

18. The semiconductor memory device as recited in claim 17, wherein a first resistance ratio between the first and second resistors is different from a second resistance ratio between the third and fourth resistors.

19. The semiconductor memory device as recited in claim 18, wherein the first, second, third and fourth resistors are active resistors.

20. The semiconductor memory device as recited in claim 11, wherein the level detect signal is generated as a logic high level when the high voltage is lower than the high reference voltage.
